(19) United States
(12) Patent Application Publication
(10) Pub. No.: US 2024/0166252 A1
(43) Pub. Date: May 23, 2024

(54) Height-adjustable Multifunctional Collapsible Cart

(71) Applicant: Peiwu WU, Anhui (CN)

(72) Inventor: Peiwu WU, Anhui (CN)

(21) Appl. No.: 18/386,253

(22) Filed: Nov. 2, 2023

(30) Foreign Application Priority Data
Nov. 22, 2022 (CN) 202211464431.4

(51) Int. Cl. B62B 3/02; B62B 3/00; B62B 3/10

(52) U.S. Cl. CPC B62B 3/02; B62B 3/002; B62B 3/108; B62B 2206/006; B62B 2206/06

(57) ABSTRACT

This invention relates to the field of cart technology, particularly to a height-adjustable multifunctional collapsible cart. This invention includes a cart body, wherein the cart body comprises a lifting mechanism, left and right side wall components, front and rear cross components, bottom frame components, pull rod components, wheel components, and fabric pocket components. By designing the structure of the lifting mechanism, left and right side wall components, and front and rear cross components, the device is easy to adjust in height, increases the loading capacity, and can be adjusted to the height of a person's standing operation after installing a tabletop, making the device easier to open and fold. Furthermore, through the structure design of the wheel components and fabric pocket components, the wheels, pockets, and tabletop can be quickly assembled and disassembled, giving the cart a good commercial value.

### TECHNICAL FIELD

This invention relates to the field of cart technology, particularly to a height-adjustable multifunctional collapsible cart.

### BACKGROUND OF THE INVENTION

The cart falls into the category of outdoor recreational products and is mainly used for outdoor activities. It is used to carry outdoor activity items such as folding chairs, tents, sun umbrellas, picnic utensils, fishing gear, etc. It can also be used for transporting goods, such as shopping in supermarkets or moving parcels. It can also be equipped with a tabletop to be used as a table or mobile food cart.

The cart is a tool used for transporting items. Currently, the folding carts available in the market are fixed in size when unfolded. Their height cannot be adjusted and their carrying capacity cannot be increased. With the increasing number of outdoor equipment items, one cart cannot meet the demand for carrying a large number of items. Additionally, when a tabletop is installed on the cart, the height of the tabletop is limited to the height of the cart, resulting in a relatively low working height, making people tiring when cooking outdoors for an extended period of time. Some double-layer carts have increased carrying capacity, but it is inconvenient to carry them when folded, as they are too tall. To address these issues, we propose a multi-functional collapsible cart that can be adjusted in height.

### BRIEF SUMMARY OF THE INVENTION

This invention is to provide a collapsible and height-adjustable multifunctional cart to solve the problems mentioned in the above background technology.

To solve the above technical problems, this invention adopts the following technical solution:

A collapsible and height-adjustable multifunctional cart, comprising a cart body, wherein the said cart body comprising a lifting mechanism, left and right side wall components, front and rear cross components, bottom frame components, pull rod components, wheel components, and fabric pocket components. The four corners of the said cart are all equipped with lifting mechanisms for adjusting the height of the cart. A left and right side wall component is installed between two said lifting mechanisms on the same side, and a front and rear cross component is installed between two said lifting mechanisms on the same end. The bottom of the said cart is equipped with a bottom frame component for reinforcement and support of the cart. One end of the said cart is equipped with a pull rod component. The said left and right side wall components, front and rear cross components, and pull rod components are used to assist in folding the cart. The bottom of the said lifting mechanisms is equipped with wheel components and the inside of the said cart is equipped with fabric pocket components.

Preferably, the said lifting mechanism comprises an outer tube, an inner tube, a telescopic tube sleeve, a quick-release fixing seat, a sliding quick-release fixing seat, a first bottom frame fixing seat, a ball, a first shaft sleeve, and a first bearing. The four corners of the said cart are all equipped with the outer tube, and the inner side of the said outer tube is slidably connected with the inner tube. The upper end of the tube opening of the said outer tube is installed with the telescopic tube sleeve. The top of the said inner tube is fixed with the quick-release fixing seat. The outer side of the said outer tube is slidably connected with the sliding quick-release fixing seat. The bottom of the said outer tube is fixed with the first bottom frame fixing seat. The lower end tube opening of the said inner tube is fixed with the ball, and the outer side of the said ball is integrally fixed with a spherical projection. The spherical projection of the ball extends through the inner tube to the outside of the inner tube, and the said spherical projection is slidably connected with the inner tube. The said ball and the lower end tube opening of the said outer tube are fixed with the first shaft sleeve, and the bottom of the said first shaft sleeve is fixed with the first bearing. Multiple slots corresponding to the positions of the spherical projections are evenly distributed on the outer side of the said outer tube, and the slots are slidably connected with the spherical projections.

Preferably, the said lifting mechanism comprises a first upright tube, a second upright tube, a quick-release fixing seat, a first sliding sleeve, a second sliding sleeve b, a second bottom frame fixing seat, and a ball. The four corners of the said cart are all equipped with the first upright tube, and the top of the said first upright tube is equipped with the second upright tube. The bottom of the said second upright tube is fixed with the first sliding sleeve, and the said first sliding sleeve is slidably connected to the first upright tube. The top of all said first upright tube is fixed with the second sliding sleeve b, and the second sliding sleeve b is slidably connected to the second upright tube. The top of the said second upright tube is fixed with the quick-release fixing seat, and the bottom of the said first upright tube is fixed with the second bottom frame fixing seat. Multiple balls are fixed inside the said first upright tube, and each ball is integrally fixed with a spherical projection on the outside. The said spherical projection of the ball extends through the first upright tube to the outside of the first upright tube, and the spherical projection is slidably connected to the first upright tube. The outer side of the said first sliding sleeve is also provided with slots corresponding to the positions of the spherical projections, and the said slots are slidably connected to the spherical projections.

Preferably, the said left and right side wall components comprise a first upper connecting tube, a first long cross tube, a lower connecting tube, and a support tube. One end of all said quick-release fixing seats is rotatably connected to the first upper connecting tube, and one end of all said first upper connecting tube is rotatably connected to the first long cross tube through a pin. The middle parts of the two said first long cross tubes on the same side are rotatably connected by a pin. The bottom of each first long cross tube is rotatably connected to the said lower connecting tube through a pin. One end of all said lower connecting tube away from the first long cross tube is rotatably connected to the support tube through a pin. The bottom of all said support tube is rotatably connected to the sliding quick-release fixing seat through a pin, and the top of all said support tube is rotatably connected to the first long cross tube through a pin.

Preferably, the said left and right side wall components comprise a first upper connecting tube, a first long cross tube, a lower connecting tube, and a support tube. One end of all said quick-release fixing seats is rotatably connected to the first upper connecting tube, and one end of all said first upper connecting tube is rotatably connected to the first long cross tube through a pin. The middle parts of the two said first long cross tubes on the same side are rotatably connected by a pin. The bottom of each first long cross tube is rotatably connected to the said lower connecting tube through a pin. One end of all said lower connecting tube away from the first long cross tube is rotatably connected to the support tube through a pin. The bottom of all said support tube is rotatably connected to the sliding quick-release fixing seat through a pin, and the top of all said support tube is rotatably connected to the first long cross tube through a pin.

Preferably, the said left and right side wall components comprise a second cross tube and a third cross tube. The inner side of the said quick-release fixing seat is rotatably connected to the second cross tube, and the bottom of two said second cross tubes on the same end is rotatably connected through a pin. The middle parts of all said second cross tubes are rotatably connected to the third cross tube through a pin. The tops of two said third cross tubes on the same end are rotatably connected through a pin, and the bottoms of all said third cross tubes are rotatably connected to the sliding quick-release fixing seat through a pin.

Preferably, the said left and right side wall components comprise a second upper connecting tube, a short cross tube, a second long cross tube, and a joint member. One end of all said quick-release fixing seats is rotatably connected to the second upper connecting tube, and one end of the said second upper connecting tube is rotatably connected to the short cross tube through a joint member. The bottoms of two said short cross tubes on the same side are rotatably connected through joint members, and the middle parts of the said short cross tubes are rotatably connected to the second long cross tube through pins. The tops of two said second long cross tubes on the same side are rotatably connected through joint members, and the bottoms of all said second long cross tubes are rotatably connected to the sliding quick-release fixing seat through pins.

Preferably, the said front and rear cross components comprise a first cross tube, and the inner side of the said quick-release fixing seat is rotatably connected to the first cross tube. The middle parts of two said first cross tubes on the same end are rotatably connected through pins, and the bottoms of all said first cross tubes are rotatably connected to the sliding quick-release fixing seat through pins.

Preferably, the said front and rear cross components comprise a cross connecting tube and a fourth cross tube, and the inner side of all said quick-release fixing seat is rotatably connected to the cross connecting tube. One end of all said cross connecting tube is rotatably connected to the fourth cross tube through a pin, and the middle parts of two said fourth cross tubes on the same end are rotatably connected through pins. The bottoms of all said fourth cross tubes are rotatably connected to the sliding quick-release fixing seat through pins.

Preferably, the said front and rear cross components comprise a first connecting rod and a second connecting rod, and the inner side of the said quick-release fixing seat is rotatably connected to the first connecting rod. One end of all said first connecting rod is rotatably connected to the second connecting rod through a joint member, and the middle parts of two said second connecting rods on the same end are rotatably connected through pins. The bottoms of all said second connecting rods are rotatably connected to the sliding quick-release fixing seat through pins.

Preferably, the said bottom frame components comprise bottom tubes, fixing iron pieces, a center piece, fixing blocks, connecting holes, limiting grooves, and limiting columns. The bottoms of all said first bottom frame fixing seat are fixed with bottom tubes. One end of all said bottom tubes is fixed with a fixing iron piece. One side of four said fixing iron pieces is rotatably connected to a center piece by pins. One end of all said bottom tubes is provided with connecting holes. The said connecting holes are fixedly connected to the first bottom frame fixing seat by screws. The bottoms of all said center pieces are fixed with limiting columns. Four corners of the bottom of the said center piece are provided with limiting grooves corresponding to the positions of the bottom tubes. The said limiting grooves are in transitional fit with the bottom tubes. Both ends of all said limiting columns are fixed with two fixing blocks. The fixing blocks are rotatably connected to the fixing iron pieces.

Preferably, the said pull rod components comprise a pull rod support tube, a pull rod support connector, an outer pull rod, an inner pull rod, a rod sleeve, an inner rod plug A, an inner rod plug B, a small casting, a connecting rod head, a small steel bar, a first button, a rod connector, and a handle. One end of two said first bottom frame fixing seats on the same side is fixed with pull rod support connector. The tops of all said pull rod support connectors are rotatably connected to pull rod support tubes by pins. The tops of two said pull rod support tubes are rotatably connected to a rod connector by pins. The inner side of the said rod connector is equipped with an outer pull rod. The inside of the top of the said outer pull rod is fastened with a rod sleeve. The top of the said outer pull rod is equipped with an inner pull rod. The inner side of the bottom of the said inner pull rod is penetrated through with an inner rod plug A and an inner rod plug B. The inner rod plug A and the inner rod plug B are closely attached. A small casting is slidably connected between the said inner rod plug A and inner rod plug B. The bottom of one side of the said small casting is fixed with a first spring, which is fixedly connected to the inner side of the inner rod plug A. The front end of the said inner rod plug A and the inner rod plug B is equipped with a connecting rod head. The top of the outer side the said connecting rod head is socketed with a connecting spring. The top of the said connecting rod head is fixed with a small steel bar. The top of the said small steel bar is fixed with a first button. The top of the said inner pull rod is fixed with a handle. The said first button is slidably connected to the handle.

Preferably, the said wheel components comprise a snap ring and wheel components, wherein the said snap rings are fixed at the bottom of both said outer tubes near the handle, and the inner sides of the said snap rings are rotatably connected to the wheel components. The tops of all said wheel components are fitted with iron washers, which are in contact with the first shaft sleeve, and the bottoms of both said outer tubes away from the handle are also welded and fixed with wheel components.

Preferably, the said wheel components comprise a combination wheel, an installation shaft, a second spring, a buckle, a second button, wheel components, a second sleeve, a second bearing, and a slot. The inner side of all said outer tubes is equipped with second sleeves, and the inner side of all said second sleeve is fixed with second springs. The outer side of all said second sleeve is provided with slots corresponding to the position of the second spring. The inner side of all said slots is slidably connected with buckles. One end of the said buckle is fixed with the second spring, and the other end of the buckle is fixed with the second button. The said second button is slidably connected with the slot. The bottoms of all said second sleeve are fixed with second bearings, and the bottoms of all said second sleeve are equipped with combination wheels. The tops of all said combination wheels are fixed with installation shafts, and the tops of all said installation shafts are provided with inclined surfaces. The said installation shaft is in transitional fit with the inner side of the second bearing, and the said installation shaft is rotatably connected with the first sleeve.

Preferably, the top of the first fabric pocket is integrally sewn with a fabric cover, and the inner side of the said fabric cover is connected to an opening and closing fabric by a zipper. Both sides of the said first fabric pocket are fixed with straps.

It can be clearly seen that, through the above-mentioned technical solution herein, the technical problem targeted by this application can undoubtedly be resolved.

Meanwhile, this invention has the following advantageous effects through the above-mentioned technical solution:

1. This invention facilitates height adjustment and increases the carrying capacity through the structural design of the lifting mechanism, left and right side wall components, and front and rear cross components. After installing the tabletop, the height can be adjusted to the standing operating height, enhancing the flexibility of this device.

2. This invention enables convenient opening and folding with the structural design of the left and right side wall components, front and rear cross components, bottom frame components, and pull rod components. The device is small in size when folded. Its bottom frame has a good load-bearing capacity and the pull rod can be adjusted to multiple positions and angles, making the overall frame connection more stable.

3. This invention allows for quick assemble and disassemble of the wheels, pockets, and tabletop through the structural design of the wheel components and fabric pocket components, giving the cart a good commercial value.

### BRIEF DESCRIPTION OF THE DRAWINGS

To further illustrate the technical solution of the embodiments of this invention, a brief introduction to the drawings used in the description of the embodiments is provided below. It is evident that the drawings presented below are some embodiments of this invention. Ordinary skilled technicians in this area can obtain other drawings based on these drawings without the need for creative labor.

FIG. 1 shows the schematic diagram of the structure of this invention;

FIG. 2 shows the schematic diagram of the expanded structure of this invention;

FIG. 3 shows the schematic diagram of the connection structure between the outer tube and the second fabric pocket of this invention;

FIG. 4 shows the schematic diagram of the connection structure between the outer tube and the tabletop of this invention;

FIG. 5 shows the schematic diagram of the connection structure between the outer tube and the first upper connecting tube of this invention;

FIG. 6 shows the schematic diagram of the connection structure between the outer tube and the inner tube of this invention;

FIG. 7 shows the schematic diagram of the connection structure between the inner tube and the ball of this invention;

FIG. 8 shows the schematic diagram of the folding structure of this invention;

FIG. 9 shows the schematic diagram of the connection structure between the inner tube and the telescopic tube sleeve of this invention;

FIG. 10 shows the schematic diagram of the connection structure between the inner tube and the ball of this invention.

FIG. 11 shows a schematic diagram of the connection structure between the first upright tube and the second upright tube of this invention;

FIG. 12 shows a schematic diagram of the connection structure between the cross connecting tube and the fourth cross tube of this invention;

FIG. 13 shows a schematic diagram of the folding structure of the first upper connecting tube, the first long cross tube, the lower connecting tube, and the support tube of this invention;

FIG. 14 shows a schematic diagram of the connection structure of the first cross tube of this invention;

FIG. 15 shows a schematic diagram of the structure of the second cross tube and the third cross tube of this invention;

FIG. 16 shows a schematic diagram of the folding structure of the second cross tube and the third cross tube of this invention;

FIG. 17 shows a schematic diagram of the connection structure between the first connecting rod and the second connecting rod of this invention;

FIG. 18 shows a schematic diagram of the folding structure of the first connecting rod and the second connecting rod of this invention;

FIG. 19 shows a schematic diagram of the connection structure between the bottom support tube and the center piece of this invention;

FIG. 20 shows a schematic diagram of the connection structure between the center piece and the limiting groove of this invention.

FIG. 21 shows a schematic diagram of the connection structure between the rod support tube and the rod support connector of this invention;

FIG. 22 shows a schematic diagram of the connection structure between the outer tube and the second shaft sleeve of this invention;

FIG. 23 shows a schematic diagram of the connection structure between the first shaft sleeve and the snap ring of this invention;

FIG. 24 shows a schematic diagram of the connection structure between the quick-release fixing seat and the quick-release buckle of this invention;

FIG. 25 shows a schematic diagram of the structure of the first fabric pocket of this invention;

FIG. 26 shows a schematic diagram of the structure of the second fabric pocket of this invention;

FIG. 27 shows an enlarged schematic diagram of the structure at position A in FIG. 22 of this invention;

FIG. 28 shows a schematic diagram of the connection structure between the first fabric pocket and the strap of this invention;

FIG. 29 shows a schematic diagram of the open state of the opening and closing fabric of this invention.

In the diagrams attached, the components represented by each number are as follows:
In the diagrams: 1. Outer tube; 2. Inner tube; 3. telescopic tube sleeve; 4. Quick-release fixing seat; 5. Sliding quick-release fixing seat; 6. First bottom frame fixing seat; 7. Ball; 8. First shaft sleeve; 9. First bearing; 1a. First upright tube; 2a. Second upright tube; 5a. First sliding sleeve; 5b. Second sliding sleeve; 6a. Second bottom frame fixing seat; 10. First upper connecting tube; 11. First long cross tube; 12. Lower connecting tube; 13. Support tube; 201. First cross tube; 202. Second cross tube; 203. Third cross tube; 301. First connecting rod; 302. Second connecting rod; 303. Second upper connecting tube; 304. Short cross tube; 305. Second long cross tube; 306. Joint piece; 14. Cross connecting tube; 15. Fourth cross tube; 16. Bottom support tube; 17. Fixing iron piece; 18. Center piece; 19. Fixing block; 20. Connecting hole; 21. Limiting groove; 22. Limiting column; 23. Rod support tube; 24. Rod support connector; 25. Outer rod; 26. Inner rod; 27. Rod sleeve; 28. Inner rod plug A; 29. Inner rod plug B; 30. Small casting; 31. Connecting rod head; 32. Small steel bar; 33. First button; 34. Rod connector; 35. Handle; 36. Snap ring; 37. Combination wheel; 38. Installation shaft; 39. Second spring; 40. Buckle; 41. Second button; 42. Wheel components; 43. Quick-release buckle; 44. Table quick-release buckle; 45. First fabric pocket; 46. Second fabric pocket; 47. Tabletop; 48. Second shaft sleeve; 49. Second bearing; 50. Slot; 51. Fabric cover; 52. Opening and closing fabric; 53. Zipper; 54. Strap.

### DETAILED DESCRIPTION OF THE INVENTION

In order to make the purpose, technical solution and advantages of this invention clearer and understandable, this invention will be further described in detail in conjunction with the drawings attached and embodiments. It should be understood that the specific embodiments described herein are only used to explain this invention and are not intended to limit this invention.

### EMBODIMENT 1

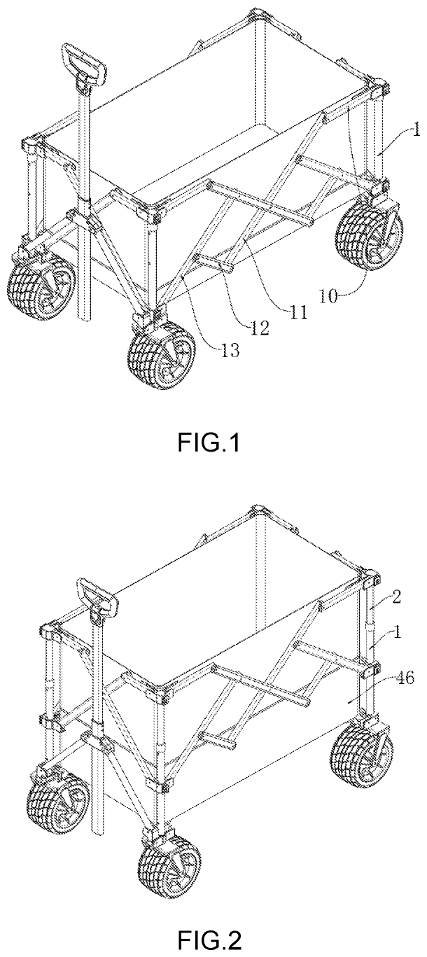

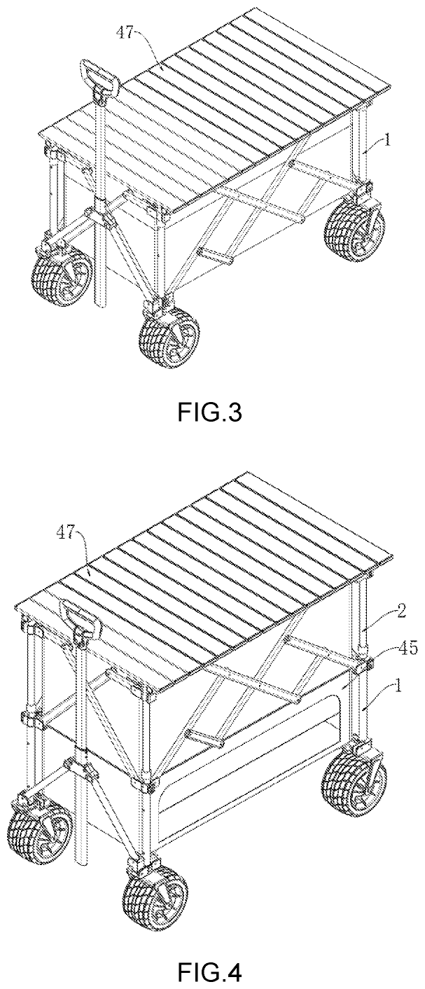

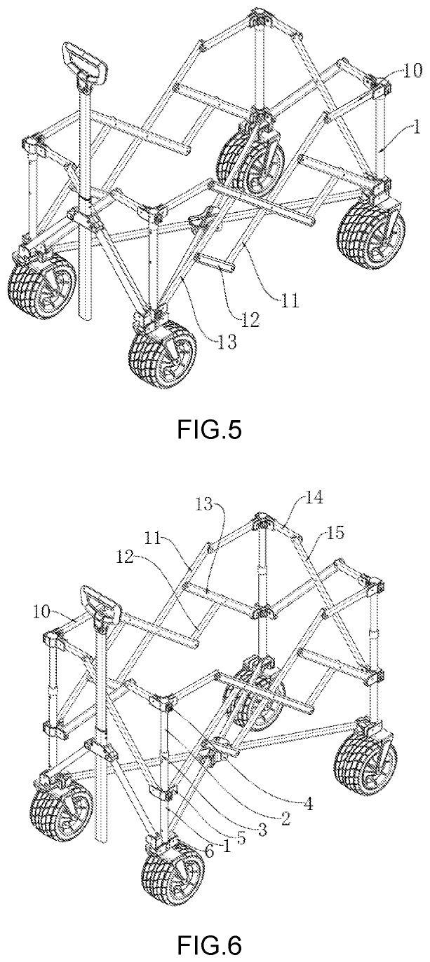

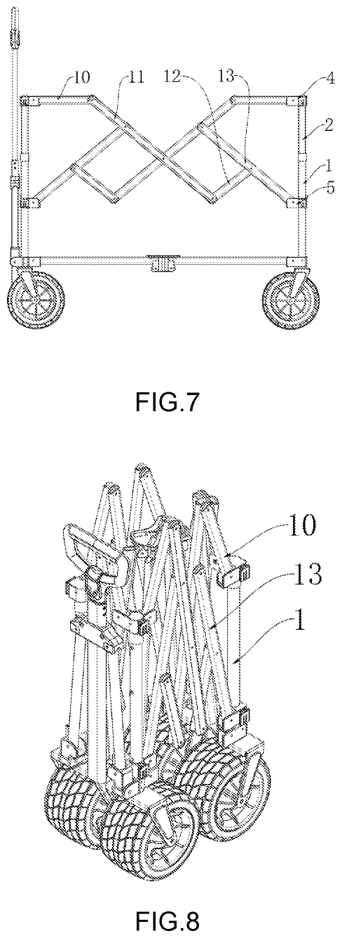

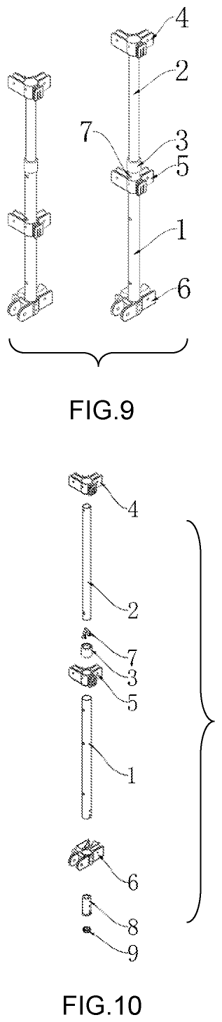

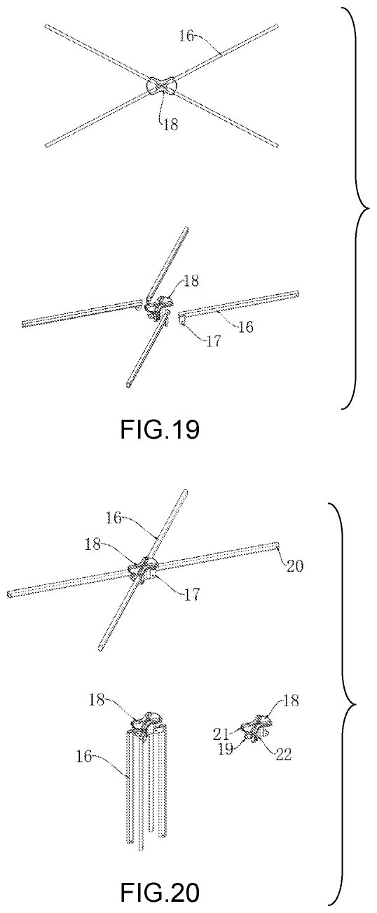

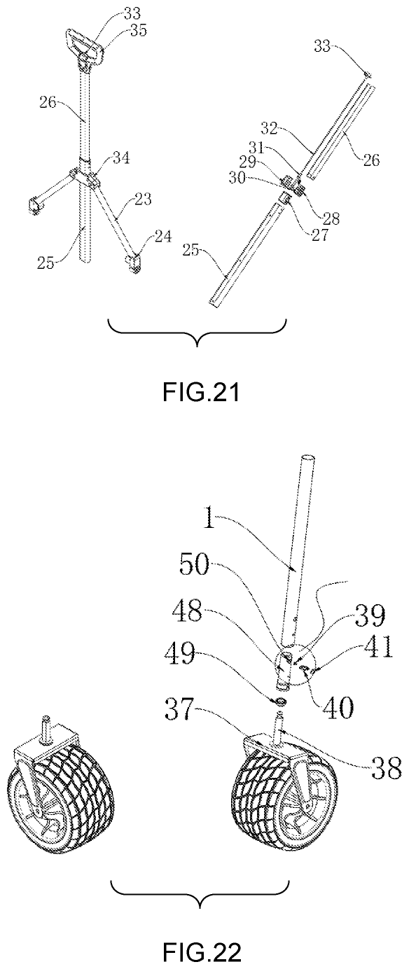

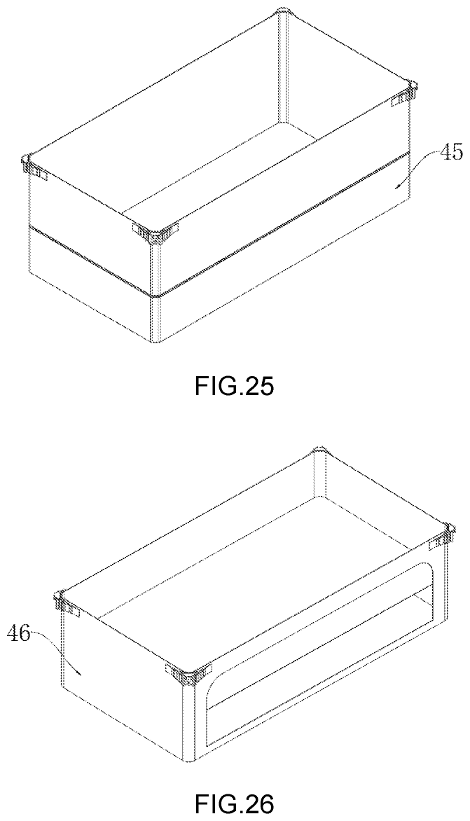

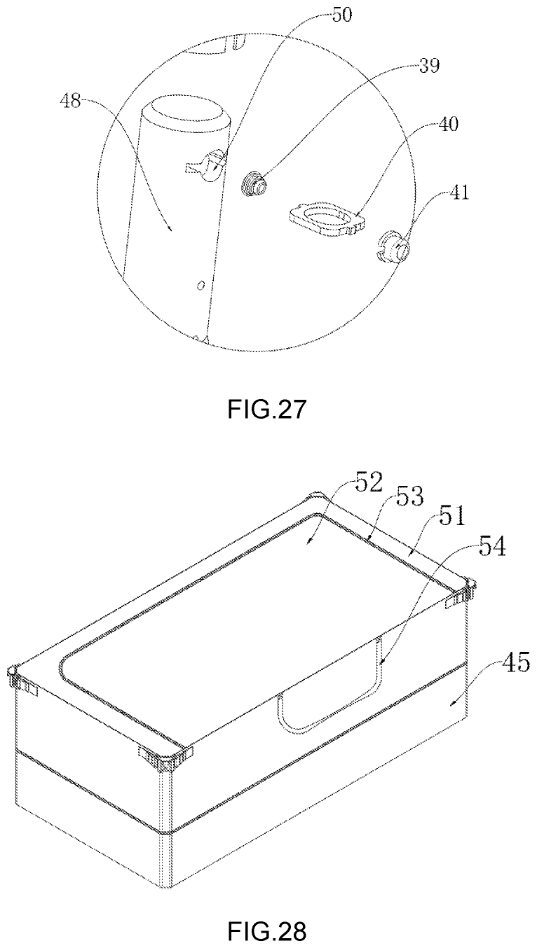

Referring to FIG. 1-27, a height-adjustable multifunctional collapsible cart includes a cart body, wherein the cart body comprises a lifting mechanism, left and right side wall components, front and rear cross components, bottom frame components, pull rod components, wheel components, and fabric pocket components. The four corners of the cart are all equipped with lifting mechanisms for adjusting the height of the cart. A left and right side wall component is assembled between two lifting mechanisms on the same side, and a front and rear cross component is assembled between two lifting mechanisms at the same end. The bottom of the cart is equipped with a bottom frame component for reinforcement and support. One end of the cart is equipped with a pull rod component. The left and right side wall components, front and rear cross components, and pull rod component are used to assist in folding the cart. The bottom of the lifting mechanisms is equipped with wheel components, and the inner side of the cart is equipped with a fabric pocket component.

The lifting mechanism comprises an outer tube 1, an inner tube 2, a telescopic tube sleeve 3, a quick-release fixing seat 4, a sliding quick-release fixing seat 5, a first bottom frame fixing seat 6, a ball 7, a first shaft sleeve 8, and a first bearing 9. The four corners of the cart are all equipped with outer tube 1, and the inner side of outer tube 1 is slidably connected with inner tube 2. The upper end of the tube opening of outer tube 1 is installed with telescopic tube sleeve 3. The top of inner tube 2 is fixed with a quick-release fixing seat 4. The outer side of outer tube 1 is slidably connected with sliding quick-release fixing seat 5. The bottom of outer tube 1 is fixed with a first bottom frame fixing seat 6. The lower end tube opening of inner tube 2 is fixed with a ball 7, and the outer side of ball 7 is integrally fixed with a spherical projection. The spherical projection of ball 7 extends through inner tube 2 to the outside of inner tube 2, and the spherical projection is slidably connected with inner tube 2. Ball 7 and the lower end tube opening of outer tube 1 are both fixed with a first shaft sleeve 8, and the bottom of first shaft sleeve 8 is fixed with a first bearing 9. Multiple slot holes corresponding to the positions of the spherical projection are evenly distributed on the outer side of outer tube 1. The slot hole is slidably connected to the spherical projection. When it is necessary to adjust the height of the cart, press the spherical projection on the ball 7 to make the spherical projection retract into the slot hole, causing the ball 7 to be compressed and deformed. Then, pull the inner tube 2 to make the spherical projection move into the outer tube 1, so that the inner tube 2 can move upward along the inner side of outer tube 1. After that, move the spherical projection to the slot hole corresponding to the specified position. When the spherical projection contacts the slot hole, the elastic force generated by ball 7 pushes the spherical projection into the slot hole until the spherical projection is fully connected with the slot hole, thus realizing the height adjustment of the cart.

The left and right side wall components include a first upper connecting tube 10, a first long cross tube 11, a lower connecting tube 12, and a support tube 13. One end of the quick-release fixing seat 4 is rotatably connected to the first upper connecting tube 10. One end of the first upper connecting tube 10 is rotatably connected to the first long cross tube 11 through a pin. The middle parts of the two first long cross tubes 11 on the same side are rotatably connected by pins. The bottom of the first long cross tube 11 is rotatably connected to the lower connecting tube 12 through pins. The end of the lower connecting tube 12 away from the first long cross tube 11 is rotatably connected to the support tube 13 through pins. The bottom of the support tube 13 is rotatably connected to the sliding quick-release fixing seat 5 through pins. The top of the support tube 13 is rotatably connected to the first long cross tube 11 through pins. When it is necessary to fold the cart forwards and backwards, the first bottom frame fixing seat 6 is detached from the bottom support tube 16. When the outer tubes 1 at both ends are pushed towards each other, because the first upper connecting tube 10 is rotatably connected to the first long cross tube 11 through pins, the first upper connecting tube 10 is rotatably connected to the quick-release fixing seat 4 through pins, and the first long cross tube 11 is rotatably connected to the support tube 13 through pins, and the support tube 13 is rotatably connected to the lower connecting tube 12 through pins, the two first long cross tubes 11 can rotate in opposite directions, thus realizing the folding of the cart.

The front and rear cross components include a first cross tube connecting hole 201. The inner side of the quick-release fixing seat 4 is rotatably connected to the first cross tube connecting hole 201. The two first cross tube connecting holes 201 on the same end are rotatably connected by a pin in the middle. The bottom of the first cross tube connecting hole 201 is rotatably connected to the sliding quick-release fixing seat 5 through a pin. When it is necessary to fold the cart leftwards and rightwards, the first bottom frame fixing seat 6 is detached from the bottom support tube 16, and the outer tubes 1 on both sides are pushed towards each other. Because the second cross tube 202 is rotatably connected to the quick-release fixing seat 4 through a pin, and the second cross tube 202 is rotatably connected to the first bottom frame fixing seat 6 through a pin, the two second cross tubes 202 rotate in opposite directions, thus realizing the folding of the cart.

The bottom frame components comprise bottom support tubes 16, fixing iron pieces 17, a central piece 18, fixing blocks 19, connecting holes 20, positioning slots 21, and positioning columns 22. The bottom of the first bottom frame fixing seat 6 is fixed with bottom support tube 16. One end of the bottom support tube 16 is fixed with fixing iron piece 17. One side of the four fixing iron pieces 17 is connected to a central piece 18 through pins for rotation. One end of the bottom support tube 16 is provided with connecting hole 20, which are fixedly connected to the first bottom frame fixing seat 6 by screws. The bottom of the central piece 18 is fixed with positioning column 22. The four corners at the bottom of the central piece 18 are provided with positioning slots 21 corresponding to the position of the bottom support tube 16. The positioning slot 21 is in transitional fit with the bottom support tube 16. Both ends of the positioning column 22 are fixed with two fixing blocks 19, which are rotationally connected to the fixing iron pieces 17. The bottom support tube 16 can rotate 90° around the fixing block 19 on the central piece 18. When the bottom support tube 16 rotates to a horizontal state, the positioning slot 21 and positioning column 22 contact the bottom support tube 16, while the other end of the bottom support tube 16 is fixed to the first bottom frame fixing seat 6 through screws and connecting hole 20, thereby restricting its movement and forming a flat surface capable of supporting the weight of an object.

The pull rod components comprise pull rod support tubes 23, pull rod support connectors 24, an outer pull rod 25, an inner pull rod 26, a rod sleeve 27, an inner pull rod plug A 28, an inner pull rod plug B 29, a small casting 30, a connecting rod head 31, a small steel bar 32, a first button 33, a rod connector 34, and a handle 35. One end of two first bottom frame fixing seats 6 on the same end is fixed with a pull rod support connector 24. The top of the pull rod support connector 24 is rotatably connected to the pull rod support tube 23 through a pin. The top of the two pull rod support tubes 23 is rotatably connected to a rod connector 34 through a pin. The inner side of the rod connector 34 is fitted with an outer pull rod 25. The top inner side of the outer pull rod 25 is engaged with the rod sleeve 27. The top of the outer pull rod 25 is fitted with an inner pull rod 26. The inner bottom side of the inner pull rod 26 is provided with the inner pull rod plug A 28 and the inner pull rod plug B 29, which fit tightly together. A small casting 30 is slidably connected between the inner pull rod plug A 28 and the inner pull rod plug B 29. The bottom of one side of the small casting 30 is fixed with a first spring, which is fixedly connected to the inner side of the inner pull rod plug A 28. The front end of the inner pull rod plug A 28 and the inner pull rod plug B 29 is equipped with a connecting rod head 31. The top of the outer side of the connecting rod head 31 is socketed with a connecting spring. The top of the connecting rod head 31 is fixed with a small steel bar 32. The top of the small steel bar 32 is fixed with a first button 33. The top of the inner pull rod 26 is fixed with a handle 35. The first button 33 is slidably connected to the handle 35. When the inner pull rod 26 is pulled out, the small casting 30 inside the inner pull rod plug A 28 and the inner pull rod plug B 29 pops out under the action of the first spring, aligning with the first outer hole on the outer pull rod 25, and the inner pull rod 26 is adjusted to the first level. Press down the first button 33 again, and the small casting 30 retracts. Continue to pull up the handle 35. When the inner pull rod plug A 28 and the inner pull rod plug B 29 contact the rod sleeve 27, the inner pull rod 26 can no longer be pulled out. At the same time, the small casting 30 pops out under the action of the first spring, aligning with the second outer hole on the outer pull rod 25. Release the first button 33, and the small casting 30 pops out under the action of the first spring. At this time, the inner pull rod 26 is adjusted to the second level. When retracting, press the first button 33, and the small casting 30 retracts. Push down the handle 35, and the inner pull rod 26 retracts into the outer pull rod 25.

The wheel components comprise a snap ring 36 and a wheel component 42. Two snap rings 36 are fixed at the bottom of two outer tubes 1, located near handle 35. The inner side of snap rings 36 is rotatably connected to wheel component 42. The top of wheel component 42 is fitted with iron washers. Iron washers are in contact with the first shaft sleeve 8. At the bottom of two outer tubes 1, which are far from handle 35, wheel component 42 is also welded and fixed. When it is necessary to move the cart, wheel component 42 is pushed by handle 35 to move, allowing the user to quickly move the cart to the designated area.

The fabric pocket components comprise quick-release buckles 43, a table quick-release buckles 44, a first fabric pocket 45, and a table top 47. The interior of the cart is equipped with the first fabric pocket 45, and all four corners of the first fabric pocket 45 are connected to the sliding quick-release fixing seat 5. The first fabric pocket 45 is internally divided into compartments. The four corners of the first fabric pocket 45 are fixed with quick-release buckles 43, which are fastened to the quick-release fixing seat 4. The top of the quick-release fixing seat 4 is equipped with table quick-release buckles 44, which are in transitional fit with the inner side of the quick-release fixing seat 4. A number of table quick-release buckles 44 are connected to a table top 47. The four corners of the first fabric pocket 45 are fixed on the sliding quick-release fixing seat 5 respectively. The cart can also be equipped with a second fabric pocket 46. When we need to raise the frame, the first fabric pocket 45 can be replaced with the second fabric pocket 46. By unzipping the zipper on the second fabric pocket 46, it can also be raised accordingly. At this time, the cart can carry more items. When we continue to raise the frame to the highest position and install the table top 47, as well as the first fabric pocket 45 of the upper and lower layers, the cart can be used as a mobile food cart.

### EMBODIMENT 2

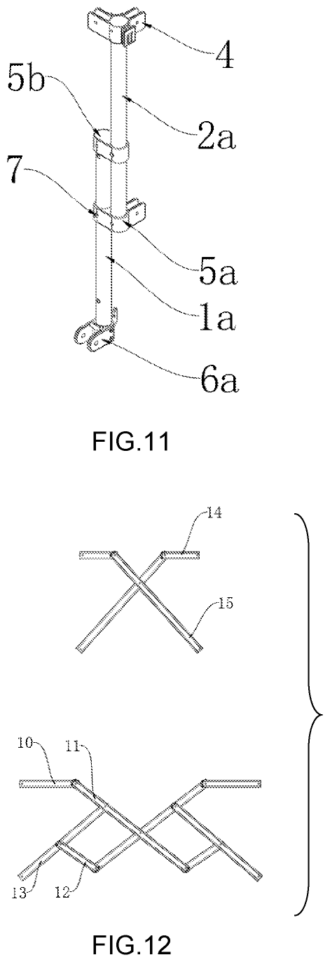

Referring to FIG. 11, this embodiment differs from Embodiment 1 only in the lifting mechanism. The lifting mechanism comprises a first upright tube 1a, a second upright tube 2a, a quick-release fixing seat 4, a first sliding sleeve 5a, a second sliding sleeve 5b, a second bottom frame fixing seat 6a, and a ball 7. The four corners of the cart are all fitted with the first upright tube 1a, and the top of the first upright tube 1a is fitted with the second upright tube 2a. The bottom of the second upright tube 2a is fixed with the first sliding sleeve 5a, which is slidably connected to the first upright tube 1a. The top of the first upright tube 1a is fixed with the second sliding sleeve 5b, which is slidably connected to the second upright tube 2a. The top of the second upright tube 2a is fixed with the quick-release fixed seat 4. The bottom of the first upright tube 1a is fixed with the second bottom frame fixing seat 6a. A number of balls 7 are fixed on the inner side of the first upright tube 1a, and each ball 7 is integrally fixed with a spherical projection on the outer side. The spherical projection of the ball 7 extends through the first upright tube 1a to the outside of the first upright tube 1a, and is slidably connected to the first upright tube 1a. The outer side of the first sliding sleeve 5a is provided with slot holes corresponding to the positions of the spherical projections. The slot holes are slidably connected to the spherical projections. When it is necessary to adjust the height of the cart, press the spherical projection on the ball 7 to make the spherical projection contract into the slot hole, causing the ball 7 to be compressed and deformed. Then, pull the second upright tube 2a to position the spherical projection inside the first sliding sleeve 5a, thereby enabling the first sliding sleeve 5a to move upward along the outer side of the first upright tube 1a. Then, move the first sliding sleeve 5a to the position corresponding to the specified spherical projection. When the spherical projection touches the slot hole, the elastic force generated by the ball 7 pushes the spherical projection to move into the slot hole until the spherical projection is completely connected to the slot hole, thereby realizing the lifting adjustment of the cart.

### EMBODIMENT 3

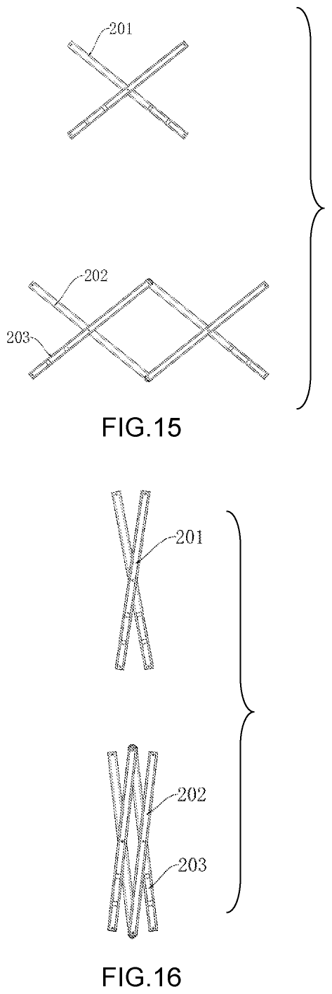

Referring to FIG. 15 and FIG. 16, this embodiment differs from Embodiment 1 only in the left and right side wall components. The left and right side wall components comprise the second cross tube 202 and the third cross tube 203. The inner side of the quick-release fixing seat 4 is rotatably connected to the second cross tube 202. The bottoms of the two second cross tubes 202 at the same end are rotatably connected through pins. The middle parts of the second cross tubes 202 are rotatably connected to the third cross tube 203 through pins. The tops of the two third cross tubes 203 at the same end are rotatably connected through pins. The bottoms of the third cross tubes 203 are rotatably connected to the sliding quick-release fixing seat 5 through pins. When it is necessary to fold the cart forwards and backwards, the first bottom frame fixing seat 6 is detached and separated from the bottom support tube 16. The outer tubes 1 located at both ends are pushed towards each other. Since the second cross tube 202 and the third cross tube 203 are rotatably connected through pins, the second cross tube 202 and the quick-release fixing seat 4 are rotatably connected through pins, and the third cross tube 203 and the first bottom frame fixing seat 6 are rotatably connected through pins. The second cross tube 202 and the third cross tube 203 can be rotated in opposite directions, thereby realizing the folding of the cart.

### EMBODIMENT 4

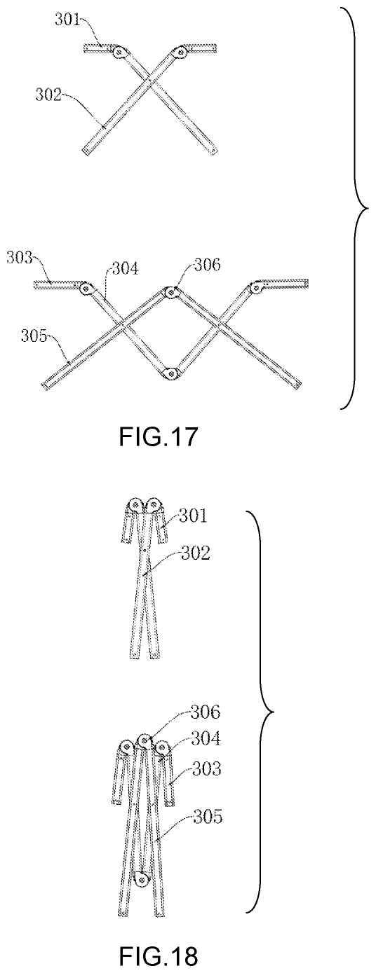

Referring to FIGS. 17 and 18, this embodiment differs from Embodiment 1 only in the left and right side wall components. The left and right side wall components comprise a second upper connecting tube 303, a short cross tube 304, a second long cross tube 305, and a joint member 306. One end of the quick-release fixing seat 4 is rotatably connected to the second upper connecting tube 303, and one end of the second upper connecting tube 303 is rotatably connected to the short cross tube 304 through the joint member 306. The bottoms of the two short cross tubes 304 on the same side are connected by the joint member 306 for rotation. The middle of the short cross tube 304 is connected to the second long cross tube 305 for rotation through a pin. The tops of the two second long cross tubes 305 on the same side are connected by the joint member 306 for rotation. The bottoms of the second long cross tubes 305 are connected to the sliding quick-release fixing seat 5 for rotation through pins. When it is necessary to fold the cart forwards and backwards, the first bottom frame fixing seat 6 is detached and separated from the bottom support tube 16, and the outer tubes 1 at both ends are pushed towards each other. Because the second upper connecting tube 303 is connected to the short cross tube 304 for rotation through pins, the second upper connecting tube 303 is connected to the quick-release fixing seat 4 for rotation through pins, and the short cross tube 304 is connected to the second long cross tube 305 for rotation through pins, and the second long cross tube 305 is connected to the first bottom frame fixing seat 6 for rotation through pins, the two short cross tubes 304 can rotate in opposite directions, thus realizing the folding of the cart.

### EMBODIMENT 5

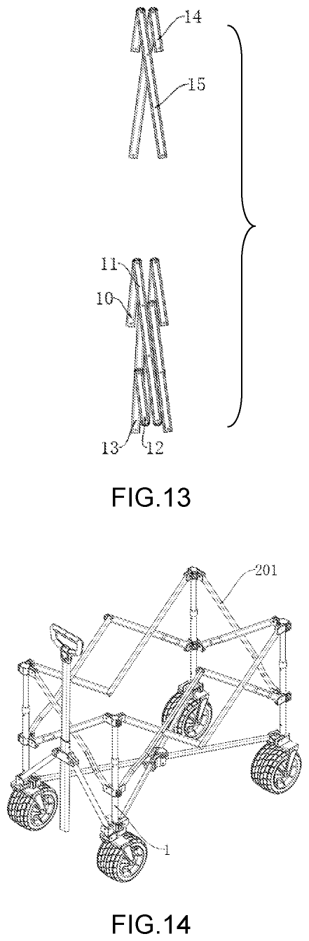

Referring to FIG. 12 and FIG. 13, this embodiment differs from Embodiment 1 only in the front and rear cross components. The front and rear cross components comprise the cross connecting tube 14 and the fourth cross tube 15. The inner sides of the quick-release fixing seats 4 are rotatably connected to the cross connecting tube 14. One end of the cross connecting tube 14 is rotatably connected to the fourth cross tube 15 through a pin. The middle part of the fourth cross tube 15 on the same end is rotatably connected through a pin. The bottom of the fourth cross tube 15 is rotatably connected to the sliding quick-release fixing seat 5 through pins. When it is necessary to fold the cart leftwards and rightwards, the first bottom frame fixing seat 6 is detached and separated from the bottom support tube 16. When the outer tubes 1 on both sides are pushed towards each other, because the cross connecting tube 14 and the quick-release fixing seat 4 are rotatably connected through pins, the cross connecting tube 14 and the fourth cross tube 15 are rotatably connected through pins, and the fourth cross tube 15 and the first bottom frame fixing seat 6 are rotatably connected through pins, the two fourth cross tubes 15 rotate in opposite directions, thus realizing the folding of the cart.

### EMBODIMENT 6

Referring to FIG. 17 and FIG. 18, this embodiment differs from Embodiment 1 only in the front and rear cross components. The front and rear cross components comprise a first connecting rod 301 and a second connecting rod 302. The inner sides of the quick-release fixing seat 4 are rotatably connected to the first connecting rod 301. One end of the first connecting rod 301 is rotatably connected to the second connecting rod 302 through a joint member 306. The middle parts of the two second connecting rods 302 on the same end are rotatably connected through a pin. The bottoms of the second connecting rods 302 are rotatably connected to the sliding quick-release fixing seat 5 through pins. When it is necessary to fold the cart leftwards and rightwards, the first bottom frame fixing seat 6 is detached from the bottom support tube 16, and the outer tubes 1 on both sides are pushed towards each other. Because the first connecting rod 301 is rotatably connected to the quick-release fixing seat 4 through a pin, the first connecting rod 301 is rotatably connected to the second connecting rod 302 through the joint member 306, and the second connecting rod 302 is rotatably connected to the first bottom frame fixing seat 6 through a pin. The middle parts of the two second connecting rods 302 on the same end are rotatably connected through a pin. Therefore, the two second connecting rods 302 can rotate in opposite directions, thus realizing the folding of the cart.

### EMBODIMENT 7

Referring to FIGS. 22-27, this embodiment differs from Embodiment 1 only in the wheel components. The wheel components comprise a combination wheel 37, an installation shaft 38, a second spring 39, a buckle 40, a second button 41, a wheel component 42, a second shaft sleeve 48, a second bearing 49, and a slot 50. The inner side of the outer tube 1 is equipped with the second shaft sleeve 48, and the inner side of the second shaft sleeve 48 is fixed with the second spring 39. The outer side of the second shaft sleeve 48 is provided with a slot 50 corresponding to the position of the second spring 39. The inner side of the slot 50 is slidably connected with the buckle 40, one end of which is fixed with the second spring 39. The other end of the buckle 40 is fixed with the second button 41, which is slidably connected to the slot 50. The bottom of the second shaft sleeve 48 is fixed with the second bearing 49, and the bottom of the second shaft sleeve 48 is equipped with the combination wheel 37. The top of the combination wheel 37 is fixed with the installation shaft 38, and the top of the installation shaft 38 is provided with a slope. The installation shaft 38 is in transitional fit with the inner side of the second bearing 49, and the installation shaft 38 is rotatably connected to the first shaft sleeve 8.

When the installation shaft 38 is inserted into the second shaft sleeve 48, the slope of the installation shaft 38 can push open the buckle 40 under the action of thrust. The buckle 40 moves inward in the slot set on the second shaft sleeve 48. When the installation shaft 38 is fully inserted, the buckle 40 moves outward and resets under the force of the second spring 39, and at the same time, the buckle 40 is locked in the slot 50 on the wheel component shaft. In this way, the installation shaft 38 is locked and the quick installation is completed.

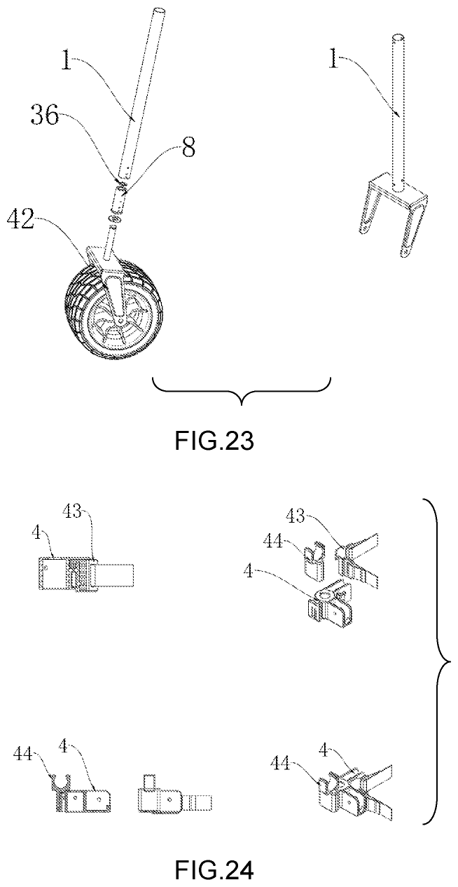

The center hole of the second shaft sleeve 48 is circular, and the installation shaft 38 can rotate 360 degrees around the axis of the wheel shaft sleeve. When the center hole of the second shaft sleeve 48 is triangular, quadrilateral, or polygonal, and the wheel shaft on the installation shaft 38 is also of a matching shape, as shown in FIG. 23, the installation shaft 38 cannot rotate after being inserted into the second shaft sleeve 48.

When we press the second button 41, the buckle 40 moves inward, leaving the slot 50 on the second shaft sleeve 48. At this time, the installation shaft 38 can be pulled out of the second shaft sleeve 48, realizing quick disassembly. When the second button 41 is released, the buckle 40 resets under the force of the second spring 39.

### EMBODIMENT 8

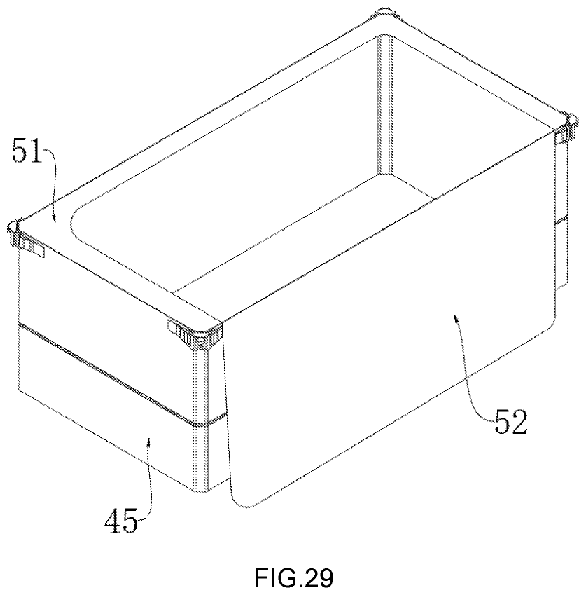

Referring to FIG. 28 and FIG. 29, this embodiment further optimizes itself. The top of the first fabric pocket 45 is stitched together with a fabric cover 51. The inner side of the fabric cover 51 is connected to an opening and closing fabric 52 by a zipper 53. Both sides of the first fabric pocket 45 are fixed with straps 54. When it is necessary to place items inside the first fabric pocket 45, the zipper 53 can be opened, causing the opening and closing fabric 52 to open, which facilitates the user in putting items inside the first fabric pocket 45. Meanwhile, when detaching the first fabric pocket 45, the user can carry it conveniently by the straps 54, thereby increasing the practicality and versatility of the first fabric pocket 45.

The above description and illustration present the basic principles, main features, and advantages of this invention. Technicians in this field should understand that this invention is not limited to the above embodiments. The above embodiments and descriptions only describe the principles of this invention. Without departing from the spirit and scope of this invention, various changes and improvements can be made, and these changes and improvements fall within the scope of protection as defined by the attached claims and their equivalents.

What is claimed is:

1. A height-adjustable multifunctional collapsible cart, characterized in that the said cart comprising a cart body, wherein the said cart body comprises a lifting mechanism, left and right side wall components, front and rear cross components, bottom frame components, pull rod components, wheel components, and fabric pocket components. The four corners of the said cart are all equipped with lifting mechanisms for adjusting the height of the cart. A left and right side wall component is assembled between two said lifting mechanisms on the same side, and a front and rear cross component is installed between two said lifting mechanisms on the same end. The bottom of the said cart is equipped with a bottom frame component for reinforcement and support of the cart. One end of the said cart is equipped with a pull rod component. The said left and right side wall components, front and rear cross components, and pull rod components are used to assist in folding the cart. The bottom of the said lifting mechanism is equipped with wheel components, and the inside of the said cart is equipped with fabric pocket components.

2. A height-adjustable multifunctional collapsible cart, as described in claim 1, characterized in that the said lifting mechanism comprising an outer tube (1), an inner tube (2), a telescopic tube sleeve (3), a quick-release fixing seat (4), a sliding quick-release fixing seat (5), a first bottom frame fixing seat (6), a ball (7), a first shaft sleeve (8), and a first bearing (9). The four corners of the said cart are all equipped with the outer tube (1), and the inner side of the said outer tube (1) is slidably connected with the inner tube (2). The upper end of the tube opening of the said outer tube (1) is installed with the telescopic tube sleeve (3). The top of the said inner tube (2) is fixed with the quick-release fixing seat (4). The outer side of the said outer tube (1) is slidably connected with the sliding quick-release fixing seat (5). The bottom of the said outer tube (1) is fixed with the first bottom frame fixing seat (6). The lower end tube opening of the said inner tube (2) is fixed with the ball (7), and the outer side of the said ball (7) is integrally fixed with a spherical projection. The spherical projection of the ball (7) extends through the inner tube (2) to the outside of the inner tube (2), and the said spherical projection is slidably connected with the inner tube (2). The said ball (7) and the lower end tube opening of the said outer tube (1) are fixed with the first shaft sleeve (8), and the bottom of the said first shaft sleeve (8) is fixed with the first bearing (9). Multiple slots corresponding to the positions of the spherical projections are evenly distributed on the outer side of the said outer tube (1), and the slots are slidably connected with the spherical projections.

3. A height-adjustable multifunctional collapsible cart, as described in claim 1, characterized in that the said lifting mechanism comprises a first upright tube (1a), a second upright tube (2a), a quick-release fixing seat (4), a first sliding sleeve (5a), a second sliding sleeve (5b), a second bottom frame fixing seat (6a), and a ball (7). The four corners of the said cart are all equipped with the first upright tube (1a), and the top of the said first upright tube (1a) is equipped with the second upright tube (2a). The bottom of the said second upright tube (2a) is fixed with the first sliding sleeve (5a), and the said first sliding sleeve (5a) is slidably connected to the first upright tube (1a). The top of all said first upright tube (1a) is fixed with the second sliding sleeve (5b), and the second sliding sleeve (5b) is slidably connected to the second upright tube (2a). The top of the said second upright tube (2a) is fixed with the quick-release fixing seat (4), and the bottom of the said first upright tube (1a) is fixed with the second bottom frame fixing seat (6a). Multiple balls (7) are evenly fixed inside the said first upright tube (1a), and each ball (7) is integrally fixed with a spherical projection on the outside. The said spherical projection of the ball (7) extends through the first upright tube (1a) to the outside of the first upright tube (1a), and the spherical projection is slidably connected to the first upright tube (1a). The outer side of the said first sliding sleeve (5a) is also provided with slots corresponding to the positions of the spherical projections, and the said slots are slidably connected to the spherical projections.

4. A height-adjustable multifunctional collapsible cart, as described in claim 2, characterized in that the said left and right side wall components comprising a first upper connecting tube (10), a first long cross tube (11), a lower connecting tube (12), and a support tube (13). One end of all said quick-release fixing seats (4) is rotatably connected to the first upper connecting tube (10), and one end of all said first upper connecting tube (10) is rotatably connected to the first long cross tube (11) through a pin. The middle parts of the two said first long cross tubes (11) on the same side are rotatably connected by a pin. The bottom of each first long cross tube (11) is rotatably connected to the said lower connecting tube (12) through a pin. One end of all said lower connecting tube (12) away from the first long cross tube (11) is rotatably connected to the support tube (13) through a pin. The bottom of all said support tube (13) is rotatably connected to the sliding quick-release fixing seat (5) through a pin, and the top of all said support tube (13) is rotatably connected to the first long cross tube (11) through a pin.

5. A height-adjustable multifunctional collapsible cart, as described in claim 2, characterized in that the said left and right side wall components comprising a second cross tube (202) and a third cross tube (203). The inner side of the said quick-release fixing seat (4) is rotatably connected to the second cross tube (202), and the bottom of two said second cross tubes (202) on the same end is rotatably connected through a pin. The middle parts of all said second cross tubes (202) are rotatably connected to the third cross tube (203) through a pin. The tops of two said third cross tubes (203) on the same end are rotatably connected through a pin, and the bottoms of all said third cross tubes (203) are rotatably connected to the sliding quick-release fixing seat (5) through a pin.

6. A height-adjustable multifunctional collapsible cart, as described in claim 2, characterized in that the said left and right side wall components comprising a second upper connecting tube (303), a short cross tube (304), a second long cross tube (305), and a joint member (306). One end of all said quick-release fixing seats (4) is rotatably connected to the second upper connecting tube (303), and one end of the said second upper connecting tube (303) is rotatably connected to the short cross tube (304) through a joint member (306). The bottoms of two said short cross tubes (304) on the same side are rotatably connected through joint members (306), and the middle parts of the said short cross tubes (304) are rotatably connected to the second long cross tube (305) through pins. The tops of two said second long cross tubes (305) on the same side are rotatably connected through joint members (306), and the bottoms of all said second long cross tubes (305) are rotatably connected to the sliding quick-release fixing seat (5) through pins.

7. A height-adjustable multifunctional collapsible cart, as described in claim 2, characterized in that the said front and rear cross components comprise a first cross tube (201), and the inner side of the said quick-release fixing seat (4) is rotatably connected to the first cross tube (201). The middle parts of two said first cross tubes (201) on the same end are rotatably connected through pins, and the bottoms of all said first cross tubes (201) are rotatably connected to the sliding quick-release fixing seat (5) through pins.

8. A height-adjustable multifunctional collapsible cart, as described in claim 2, characterized in that the said front and rear cross components comprise a cross connecting tube (14) and a fourth cross tube (15), and the inner side of all said quick-release fixing seat (4) is rotatably connected to the cross connecting tube (14). One end of all said cross connecting tube (14) is rotatably connected to the fourth cross tube (15) through a pin, and the middle parts of two said fourth cross tubes (15) on the same end are rotatably connected through pins. The bottoms of all said fourth cross tubes (15) is rotatably connected to the sliding quick-release fixing seat (5) through pins.

9. A height-adjustable multifunctional collapsible cart, as described in claim 6, characterized in that the said front and rear cross components comprise a first connecting rod (301) and a second connecting rod (302), and the inner side of the said quick-release fixing seat (4) is rotatably connected to the first connecting rod (301). One end of all said first connecting rod (301) is rotatably connected to the second connecting rod (302) through a joint member (306), and the middle parts of two said second connecting rods (302) on the same end are rotatably connected through pins. The bottoms of all said second connecting rods (302) are rotatably connected to the sliding quick-release fixing seat (5) through pins.

10. A height-adjustable multifunctional collapsible cart, as described in claim 2, characterized in that the said bottom frame components comprise bottom tubes (16), fixing iron pieces (17), a center piece (18), fixing blocks (19), connecting holes (20), limiting grooves (21), and limiting columns (22). The bottoms of all said first bottom frame fixing seat (6) are fixed with bottom tubes (16). One end of all said bottom tubes (16) is fixed with a fixing iron piece (17). One side of four said fixing iron pieces (17) is rotatably connected to a center piece (18) by pins. One end of all said bottom tubes (16) is provided with connecting holes (20). The said connecting holes (20) are fixedly connected to the first bottom frame fixing seat (6) by screws. The bottoms of all said center pieces (18) are fixed with limiting columns (22). Four corner ends of the bottom of the said center piece (18) are provided with limiting grooves (21) corresponding to the positions of the bottom tubes (16). The said limiting grooves (21) are in transitional fit with the bottom tubes (16). Both ends of all said limiting columns (22) are fixed with two fixing blocks (19). The fixing blocks (19) are rotatably connected to the fixing iron pieces (17).

11. A height-adjustable multifunctional collapsible cart, as described in claim 2, characterized in that the said pull rod components comprise a pull rod support tube (23), a pull rod support connector (24), an outer pull rod (25), an inner pull rod (26), a rod sleeve (27), an inner rod plug A (28), an inner rod plug B (29), a small casting (30), a connecting rod head (31), a small steel bar (32), a first button (33), a rod connector (34), and a handle (35). One end of two said first bottom frame fixing seats (6) on the same side is fixed with the pull rod support connector (24). The tops of all said pull rod support connectors (24) are rotatably connected to pull rod support tubes (23) by pins. The tops of two said pull rod support tubes (23) are rotatably connected to a rod connector (34) by pins. The inner side of the said rod connector (34) is equipped with an outer pull rod (25). The inside of the top of the said outer pull rod (25) is fastened with a rod sleeve (27). The top of the said outer pull rod (25) is equipped with an inner pull rod (26). The inner side of the bottom of the said inner pull rod (26) is penetrated through with an inner rod plug A (28) and an inner rod plug B (29). The inner rod plug A (28) and the inner rod plug B (29) are closely attached. A small casting (30) is slidably connected between the said inner rod plug A (28) and inner rod plug B (29). The bottom of one side of the said small casting (30) is fixed with a first spring, which is fixedly connected to the inner side of the inner rod plug A (28). The front end of the said inner rod plug A (28) and the inner rod plug B (29) is equipped with a connecting rod head (31). The top of the outer side the said connecting rod head (31) is socketed with a connecting spring. The top of the said connecting rod head (31) is fixed with a small steel bar (32). The top of the said small steel bar (32) is fixed with a first button (33). The top of the said inner pull rod (26) is fixed with a handle (35). The said first button (33) is slidably connected to the handle (35).

12. A height-adjustable multifunctional collapsible cart, as described in claim 11, characterized in that the said wheel components comprise a snap ring (36) and wheel components (42), wherein the said snap rings (36) are fixed at the bottom of both said outer tubes (1) near the handle (35), and the inner side of the said snap rings (36) are rotatably connected to the wheel components (42). The tops of all said wheel components (42) are fitted with iron washers, which are in contact with the first shaft sleeve (8), and the bottoms of both said outer tubes (1) away from the handle (35) are also welded and fixed with wheel components (42).

13. A height-adjustable multifunctional collapsible cart, as described in claim 11, characterized in that the said wheel components comprise a combination wheel (37), an installation shaft (38), a second spring (39), a buckle (40), a second button (41), wheel components (42), a second sleeve (48), a second bearing (49), and a slot (50). The inner side of all said outer tubes (1) is equipped with second sleeves (48), and the inner side of all said second sleeve (48) is fixed with second springs (39). The outer side of all said second sleeve (48) is provided with slots (50) corresponding to the position of the second spring (39). The inner side of all said slots (50) is slidably connected with buckles (40). One end of the said buckle (40) is fixed with the second spring (39), and the other end of the buckle (40) is fixed with the second button (41). The said second button (41) is slidably connected with the slot (50). The bottoms of all said second sleeve (48) are fixed with second bearings (49), and the bottoms of all said second sleeve (48) are equipped with combination wheels (37). The tops of all said combination wheels (37) are fixed with installation shafts (38), and the tops of all said installation shafts (38) are provided with inclined surfaces. The said installation shaft (38) is in transitional fit with the inner side of the second bearing (49), and the said installation shaft (38) is rotatably connected with the first sleeve (8).

14. A height-adjustable multifunctional collapsible cart, as described in claim 2, characterized in that the fabric pocket components comprise a quick-release buckle (43), a table quick-release buckle (44), a first fabric pocket (45), and a table top (47). The inner side of the said cart is fixed with the first fabric pocket (45), and all four corners of the said first fabric pocket (45) are connected to sliding quick-release fixing seats (5). The said first fabric pocket (45) is internally equipped with compartments, and all four top corners of the said first fabric pocket (45) are fixed with quick-release buckles (43), which are fastened to the quick-release fixing seats (4). The top of all said quick-release fixing seat (4) is equipped with a table quick-release buckle (44), which is transitionally fit with the inner side of the quick-release fixing seat (4). The top of multiple said table quick-release buckles (44) are connected to a table top (47) by snapping together.

15. A height-adjustable multifunctional collapsible cart, as described in claim 14, characterized in that the top of the first fabric pocket (45) is integrally sewn with a fabric cover (51), and the inner side of the said fabric cover (51) is connected to an opening and closing fabric (52) by a zipper (53). Both sides of the said first fabric pocket (45) are fixed with straps (54).
